(19) United States
(12) Patent Application Publication
(10) Pub. No.: US 2007/0263603 A1
(43) Pub. Date: Nov. 15, 2007

(54) VoIP PERSONAL CALL RECORDER

(75) Inventor: Jeffrey Hugh Schmitt, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies, Inc., Murray Hill, NJ (US)

(21) Appl. No.: 11/279,910

(22) Filed: Apr. 17, 2006

(51) Int. Cl. H04L 12/66

(52) U.S. Cl. 370/356

(57) ABSTRACT

Methods and systems are presented allowing VoIP phone users and other packet-based telecommunications service subscribers to have conference call content recorded live during conference calls involving three or more parties, with the subscriber being able to selectively pause the conference to answer other calls or perform other tasks while the live conference continues, and to thereafter playback the conference at a controllable speed and to rejoin the live conference.

### BACKGROUND OF THE INVENTION

This invention relates generally to the field of telecommunications, and more particularly to methods and systems for personal recording of conference calls in packet-switched telecommunications networks. Modern telecommunications systems provide phone service to a variety of telephone devices, including traditional land-line type telephones connected to circuit-switched networks, wireless phones providing connectivity via one of a large number of wireless networks, and packet-based devices such as Voice-over-IP (VoIP) phones connected to packet-switched networks. The different network types are interconnected and operated by various service providers, with individual customers subscribing to selected services. One popular service allows a call to be joined by three or more parties, commonly referred to as a conference call, which is useful for business or other applications to hold meetings where the participants are at different locations. Certain conference call services support the normal audio exchange among conference call attendees as well as exchange of video or other data. For busy professionals, however, attending all scheduled conference calls is difficult, particularly where there are frequent conference call meetings but many schedule conflicts. Thus, in practice, it may be impossible for certain persons to participate in all the scheduled conference calls, or attendees may tune-out of the conference call for a few seconds or even several minutes to handle an interruption, to answer or place another call, or to perform other tasks while the conference call continues. In these situations, the absent party misses a portion of the rendered audio and/or video, and may then have to interrupt the call upon rejoining to inquire as to what was missed. Furthermore, the other participants may not realize that one party is not currently present, and may ask questions of the missing participant, leading to confusion and wasted time waiting for the missing party to rejoin the conversation. Accordingly, there is a need for improved conference calling services to provide conference call participants more flexibility in addressing interruptions or schedule conflicts while mitigating the adverse consequences for other attendees.

### SUMMARY OF THE INVENTION

The following is a summary of one or more aspects of the invention provided in order to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The various aspects of the present invention relate to network-based personal call recording (PCR) systems and methods to facilitate participation in conference calls by busy professionals and other subscribers of packet-based telecommunications services. Methods and telecommunications systems are provided, by which conference call audio, video, and/or data can be recorded by a network-based personal call recorder service in essentially real time and a VoIP or other packet-based telecommunications service subscriber can selectively pause his or her participation in the conference to answer other calls or to perform other tasks while the live conference continues. Meanwhile, the system can be configured to indicate to other conference attendees that the subscriber is not currently listening, so that no questions will be posed to the subscriber while he or she is away. Once the interruptions have been dealt with, the subscriber can playback a portion of the conference at a controllable speed and then rejoin the live conference. In certain implementations, moreover, the subscriber can preprogram the PCR service to attend as a proxy in lieu of the actual subscriber, whereby the conference call information (audio, video, etc.) can be stored for later reviewing by a subscriber who has a schedule conflict. The invention may thus be successfully employed to avoid or mitigate the above mentioned difficulties with conventional conference calling and to provide enhanced services for subscribers having VoIP or other packet-based telecommunications devices.

In accordance with one or more aspects of the invention, a telecommunications system is provided, including a subscriber telecommunications device, such as a VoIP phone, personal computer with a soft phone client, PDA with a WiFi interface, etc., which is coupleable to a packet-switched telecommunications network to provide packet-based telephone service to a subscriber. The system also includes a personal call recording system operatively coupled with the network to store a packet-based conference call involving two or more other parties, and to selectively playback all or a portion of the conference call to the subscriber during and/or after the conference call. In one embodiment, the PCR system is a software application or is otherwise implemented in a network server to provide personal call recording services for conference calls involving subscribers coupled with the packet-switched telecommunications network. The conference call can involve parties participating by any suitable telecommunications devices, for instance, traditional land-line telephones, VoIP phones, computers with soft phone clients, mobile wireless phones, PDAs connected to the Internet through WiFi hot spots, etc., wherein the PCR subscriber uses a packet-based device.

The PCR system stores audio, video, and/or other data for the conference call, and is operable in certain preferred implementations according to a subscriber initiated mode change commands to operate in a live mode or a proxy mode. In the proxy mode, the PCR system stores or records the live conference packet data stream and selectively plays back stored packets to the subscriber device according to subscriber playback commands. For instance, the subscriber can control or adjust the playback speed to listen into what he or she missed while catching up to the live conference, and may also change the current playback position, for instance, using forward or reverse commands via soft keys or function keys on a VoIP phone, computer-based soft phone client, PDA, etc. In certain implementations, moreover, the PCR system can provide the subscriber with an indication that he or she is currently in the proxy mode, and may provide similar indications to other conference call participants. In this manner, other VoIP or internet conference attendees will know that the subscriber is not “live” in the call at a given point, and can therefore refrain from asking the subscriber questions. In preferred embodiments, the PCR system may also be programmable by the subscriber to join or attend a given conference call in lieu of the subscriber, such as where the subscriber knows in advance that he or she has a schedule conflict but wants to have the conference audio, video, or other data available later for access or review.

Further aspects of the invention are related to methods in a telecommunications system for selective participation by a subscriber in a conference call. The method includes connecting a subscriber telecommunications device to a packet-switched telecommunications network and storing conference call packets from the network in a personal call recording system. The method further comprises selectively playing back a stored portion of the conference call packets from the personal call recording system to the subscriber during or after the conference call. In various preferred implementations, the method can further include joining the subscriber with the conference call via the packet-switched telecommunications network, and selectively operating the personal call recorder in a live mode in which the subscriber receives live packets for the conference call or in a proxy mode in which the personal call recording system stores packets from the live conference call and selectively plays back stored packets to the subscriber device according to subscriber playback commands. The method may further include indicating to the subscriber and/or to other participants whether the personal call recording system is in the proxy mode, as well as changing the current playback position and/or speed according to subscriber playback commands. Furthermore, the methods may include the personal call recording system attending the conference call in lieu of the subscriber and storing the conference call for subsequent access by the subscriber, and optionally indicating to other conference call parties that the personal call recording system is attending the conference call in lieu of the subscriber.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings. The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a system level diagram illustrating a telecommunications system including a IP packet-switched network with a network server based personal recording system in accordance with one or more aspects of the present invention;

FIG. 2A is a top plan view illustrating a subscriber telecommunications device that may be coupled to the network of FIG. 1 for packet-based telecommunications and use of the network-based personal call recording services;

FIG. 2B is a plan view illustrating exemplary user information displayed to a personal call recorder service subscriber by the device of FIG. 2A;

FIG. 3 is a simplified flow diagram illustrating programming of the personal recording system to record a scheduled conference call;

FIGS. 4A and 4B show a flow diagram illustrating a method for allowing selective participation in a conference call by a subscriber; and

FIG. 5 is a schematic diagram illustrating recorded conference call information in the personal call recording system of FIG. 1.

### DETAILED DESCRIPTION

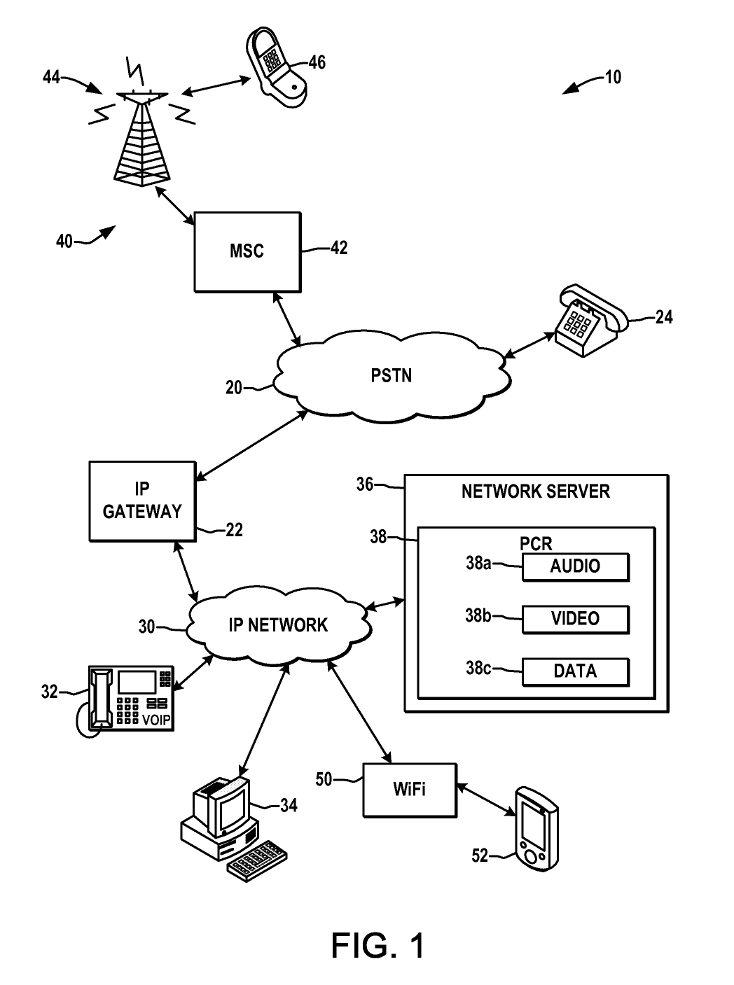

Referring now to the figures, wherein the showings are for purposes of illustrating the exemplary embodiments only and not for purposes of limiting the claimed subject matter, FIG. 1 provides a view of a system 10 into which the presently described embodiments may be incorporated. Several embodiments or implementations of the various aspects of the present invention are hereinafter illustrated and described in conjunction with the drawings, wherein like reference numerals are used to refer to like elements, and wherein the figures are not necessarily drawn to scale.

As shown in FIG. 1, the exemplary telecommunications system 10 is comprised of several operationally interconnected networks of various topologies, including a traditional wireline public switched telephone network (PSTN) 20 operatively coupled with various end offices and conventional equipment (not shown) for providing telephone services to one or more wireline telephone devices 24, where the PSTN 20 is operatively coupled using various gateways or other hardware/software interfaces (not shown) with one or more wireless networks 40 and/or Internet Protocol (IP) based networks 30 allowing connection of calls between wireline telephones 24, wireless phones or other mobile units 46 and IP-based communications equipment such as voice-over-IP (VoIP) phones 32 and/or computers 34, PDAs 52, which may either be directly connected to the IP network 30 or otherwise operatively coupled to the packet-switched network 30 via a WiFi system 50 or other operational coupling means. The wireless network 40 can include one or more mobile switching centers (MSCs) 42 and associated base station systems 44, as well as data stores such as HLRs and VLRs (not shown) providing wireless communications services for mobile phones 46, where the illustrated MSC 42 is operatively coupled with the PSTN 20 allowing calls between the wireline phone 24, the VoIP phone 32, and the mobile device 46.

The IP-based system provides an IP gateway 22 coupling the packet-switched IP network 30 with the PSTN 20 for providing call services between wireline phones 24 and IP-based devices 32, 34, 52. The various networks 20, 30, 40 thus provide communicative connection of various communications devices and network elements allowing various telephones, mobile units, computers, digital assistants, etc. to communicate with one another for exchange or transfer of voice and/or video and other data or information therebetween, wherein the telecommunications system 10 can include any number of wireless, wireline, and/or packet-switched networks, wherein only a few exemplary elements are illustrated in FIG. 1 for purposes of description without obscuring the various features and aspects of the invention. The IP network 30 allows transfer of Internet Protocol (IP) data packets, such as audio, video, data, etc., for telecommunication by users of the packet-based telephony devices 32, 34, 52 as is known.

The present invention provides a personal call recorder (PCR) system 38, implemented in a network server element 36 operatively coupled with the IP network 30, where the PCR system 38 can be implemented in any suitable hardware, software, or combinations thereof, whether integrated in a single network element (e.g., server 36 in the illustrated embodiment of FIG. 1) or the system 38 and the functionality thereof may be distributed across multiple entities and networks. In the exemplary system 10, the PCR system 38 is operative to store and selectively playback conference call packets associated with one or more subscribers to a PCR service, where the stored and played-back packets may comprise audio 38a, video 38b, and/or other data 38c associated with a conference call involving the subscriber and two or more other conference call participants or attendees. The stored conference call, moreover, may be stored in the server 36, or in one or more data stores operatively associated therewith, such that the PCR system 38 can store or save the data for later retrieval to implement the personal call recording functionality illustrated and described herein.

In the illustrated implementation, the PCR system 38 is operable to join and record conference calls, either while the subscriber is in attendance and/or on behalf of a subscriber who cannot (or chooses not to) participate in real time. In this regard, if a subscriber to the PCR service cannot attend a particular conference call, they can preprogram the PCR system 38 to join the conference call (as a proxy) for them and record the session for later playback or review. In this case, moreover, the system 38 can send messages to other participants, such as other VoIP conference attendees, indicating that the subscriber has activated the PCR system as a proxy to record the conference and that the subscriber is not a live participant, thereby mitigating the likelihood that the other participants will pose questions to the absent subscriber, and allowing the other attendees to knowingly leave messages for the subscriber with the confidence that the subscriber at least intends to review the conference call substance at a later time. In one implementation, the PCR service can send suitable IP messages to other attendees having IP phones, and will send audible indicators, such as beeps and/or prerecorded messages for all participants indicating that the conference will be recorded for later review by the subscriber.

In addition, if the subscriber later joins (or rejoins) the teleconference, the other participants may be notified, and the subscriber can then enter the proxy mode again to review all or portions of the previously stored conference call data from the PCR system, in order to “catch up” on what has already been discussed, where the subscriber can adjust the current playback position (e.g., forward, reverse, etc.) and/or playback speed (e.g., fast playback mode with or without pitch stabilization functions to allow the subscriber to hear the conversation quickly while still being able to understand the words) as desired for a quick review before rejoining the conference in a “live” operation mode. Furthermore, once the conference call is finished, the PCR system may maintain the stored conference packets for a certain time or perpetually, to allow the subscriber to subsequently review the audio 38a, video 38b, data 38c, etc. Thus, the PCR system 38 provides significant flexibility to busy professionals or anyone having schedule conflicts or interruptions during conference calls, and facilitates fuller participation by both the subscriber and other conference call participants.

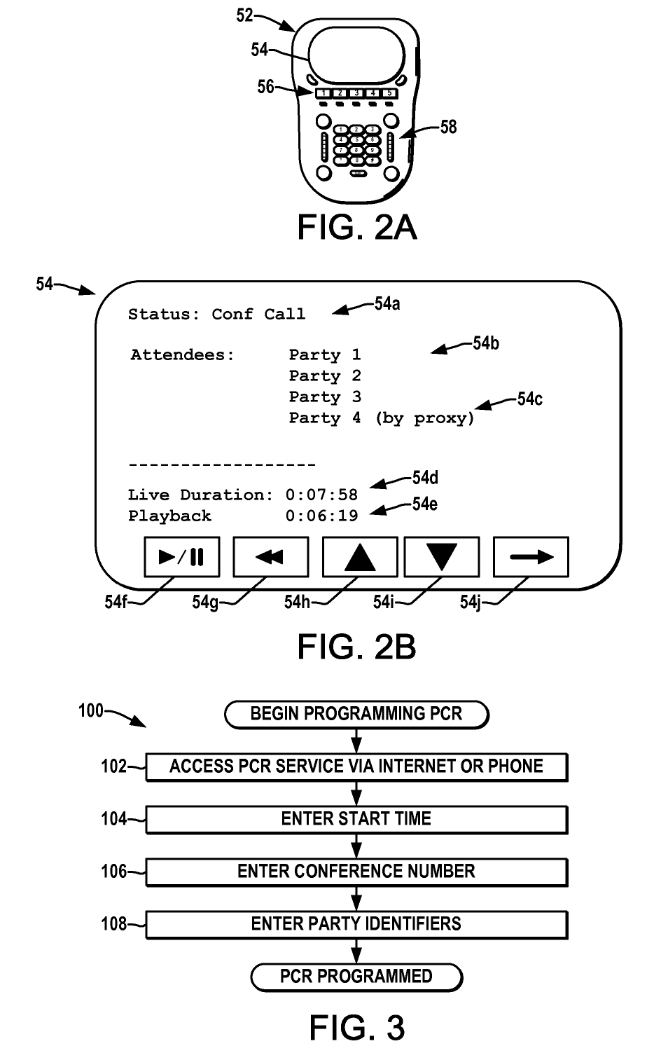

Referring also to FIGS. 2A and 2B, further details of the exemplary PDA 52 are illustrated, where the PDA 52 is coupled with the IP network 30 in FIG. 1 through WiFi system 50. For purposes of illustration, the owner of the PDA 52 in one example is a subscriber to the PCR services provided by the system 38. As best shown in FIG. 2A, the exemplary PDA 52 provides a display 54 and various user input devices, including several software definable function keys 56 and various general purpose input devices such as keys, buttons, slide wheels, etc. 58. FIG. 2B shows an example of information that can be rendered or displayed to the subscriber during operation of the PCR system 38 for a conference call involving the subscriber. In this example, the conference call is ongoing as indicated by a status indicia 54a on the display 54, and a list 54b is provided showing the current attending parties, where the subscriber is party 4 in this example.

The display 54 also provides a mode indicator 54c indicating whether the subscriber is participating real time (live) in the conference or is in a proxy mode with the PCR system 38 storing the conference packets in real time and allowing the subscriber selective playback of stored portions thereof. The proxy mode may also be indicated to other call participants, for instance, by appropriate messaging sent by the PCR system 38 to the other attendees via IP messaging or other means. In one possible example, the system 38 may send IP messaging to other non-VoIP participants, causing audible messages to be provided to such non-packet-based attendees, for instance, indicating that “Subscriber Party 4 is not currently listening, but is recording the call for later review” or “Subscriber Party 4 has just rejoined the conference call”. The display 54 also provides an indication 54d of the current length of the live conference as well as an indication 54e of the current playback position (the point in the stored conference call from which packets are currently being played back to the subscriber by the PCR system 38).

The display 54 and the PDA function keys 56 (FIG. 1) also provide various user playback controls by which the PDA 52 sends corresponding playback commands to the PCR system 38 so that the subscriber can selectively play or pause the playback or live conference 54f; rewind a few minutes (single press), return to the beginning of the conference (double press), continuously rewind (press and hold) 54g; and/or increase or decrease the playback rate or speed 54h, 54i. Moreover, in this implementation, the subscriber can also change the current playback position 54e forward or back by pausing the playback 54f and pressing either the increase or decrease button 54h or 54i, respectively. The subscriber may also toggle between live and proxy (playback) modes using a mode change button 54j to cause the system 38 to transition from live to proxy mode or to return to live participation from playback mode. Using these interface commands and the playback features of the system 38, a subscriber can join a conference call and participate in live fashion until an interruption (or prior commitment) occurs, whereupon the user can pause the session (e.g., using toggle soft key 54j) until the interruption is handled. At that point, the user can decide whether to rejoin the live conference (soft key 54j) or to start playback of the missed portion or other portions of the call using the play key 54f and the other keys 54g-54i. It is noted that because the stored/recorded conference call is IP-based, the audio/video/data can be provided to the user in playback mode in the same fashion as live participation, with the user being able to selectively modify the playback speed and/or position as desired, and the subscriber may selectively choose to rejoin the live conference whenever he or she wishes. Moreover, if the user interruption is done following completion of the conference, the user can then access the conference thereafter through the playback features of the system 38. The user interface described is merely one example, where many variations are possible for different implementations of the invention, for example, which may vary depending on user experience, end user devices, or other design considerations.

Referring also to FIG. 3, the system 38 may be started at any time to record an ongoing conference call via the user commands at the device 52. For example, a subscriber may simply join a conference call at a scheduled time, optimistically anticipating no interruptions. When an interruption occurs, however, the subscriber can merely press the soft key 54j to start the recording by the network-based PCR system 38, and the system 38 will record the call from that point onward till the conference ends of until the subscriber terminates the recording by suitable interface command. In another possible scenario, the user wisely preprograms the PCR system 38 to automatically join the conference call at a designated time (for a designated duration or until the call ends), at a designated number. In this manner, the subscriber can setup the recorder service 38 to store the entire call, regardless of whether the user intends to participate in the conference at all. Thus, the PCR system 38 can be configured to create a record of the call for later use, and in certain cases, join to participate in the subscriber's behalf as a proxy. FIG. 3 illustrates a method 100 for programming the PCR system 38 to attend a conference call, wherein the subscriber accesses the system 38 at 102, for example, via the Internet and a suitable service configuration interface, through a menu driven telephone (audio) programming environment, or other suitable interface to the system 38 through the network 30 and possibly through other intervening networks. At 104, the user enters the conference call start time, with the conference number and any necessary codes, passwords, etc. being entered at 106. Optional party identifiers may be entered at 108 to complete the programming/configuration of the system 38 for the conference call.

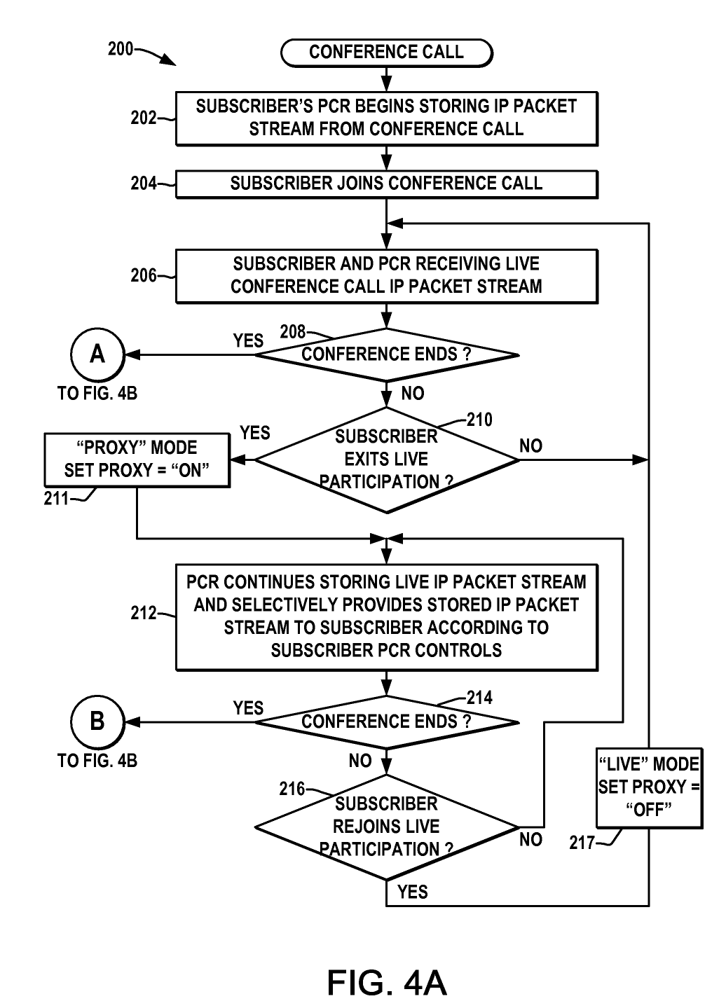

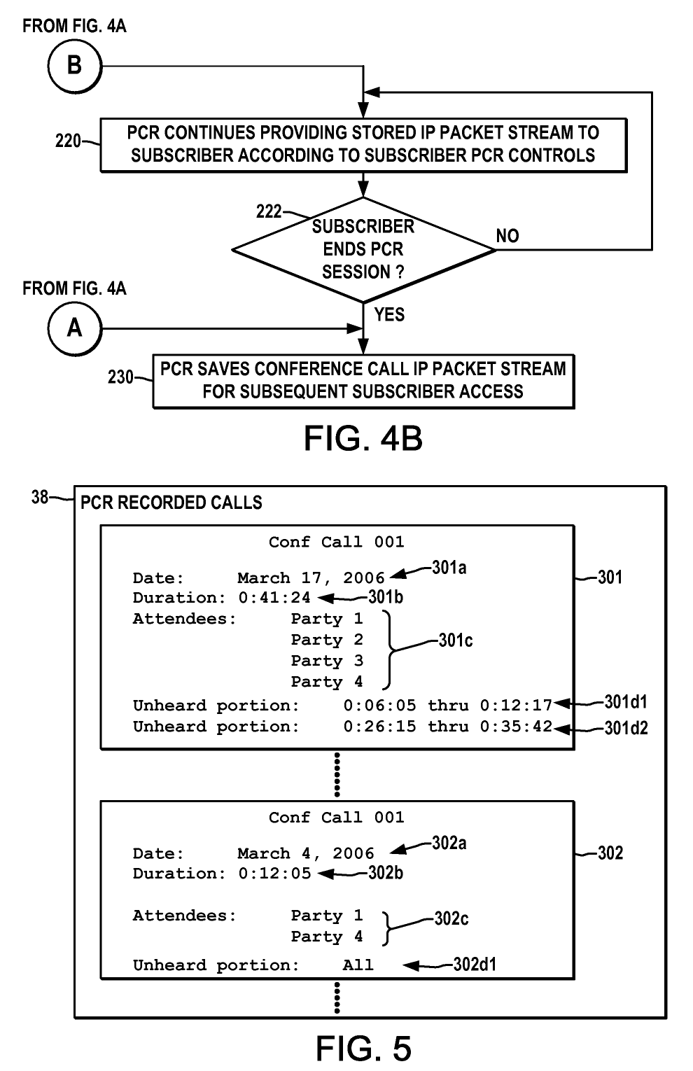

FIGS. 4A and 4B depict an exemplary method 200 illustrating operation of the system 38 in a typical conference call scenario. Although the exemplary method 200 is illustrated and described below in the form of a series of acts or events, it will be appreciated that the various methods of the invention are not limited by the illustrated ordering of such acts or events except as specifically set forth herein. In this regard, except as specifically provided hereinafter, some acts or events may occur in different order and/or concurrently with other acts or events apart from those illustrated and described herein, and not all illustrated steps may be required to implement a process or method in accordance with the present invention. The illustrated method 200 and other methods of the invention may be implemented in hardware, software, or combinations thereof, in order to provide personal call recorder services to packet-based telephony subscribers, wherein the method 200 can be practiced in hardware and/or software of the above described PCR system 38 of FIG. 1, although the invention is not limited to the specific applications and implementations illustrated and described herein.

The example of FIGS. 4A and 4B shows operation in the case where the PCR system 38 is programmed or otherwise directed by the subscriber to participate in the conference call for recording the packet content thereof, where the PCR system begins storing the conference call packet stream at 202, and the subscriber joins as a live participant at 204. In this initial state, both the subscriber (e.g., via his or her device 32, 34, 52) and the PCR system 38 receive the live conference call IP packets stream at 206. In this situation, moreover, the system 38 can operate to provide the packets to the user, or the user and the system 38 can alternatively receive packets separately. A determination is made at 208 as to whether the conference has ended. If so (YES at 208), the method 200 proceeds to 230 in FIG. 4B, where the PCR system 38 saves or stores the conference call IP packet stream for subsequent subscriber access. If, however, the conference is still ongoing (NO at 208 in FIG. 4A), a determination is made at 210 as to whether the subscriber exits live participation. If not (NO at 210), the method 200 proceeds back to 206 as described above.

However, if the user is interrupted or otherwise chooses, he or she may exit live attendance (YES at 210) and switch the PCR system 38 from “live” mode to “proxy” mode, wherein the PCR system 38 may provide a “proxy mode” indication to the subscriber device 52 and/or to other packet-based or conventional participant devices at 211 through appropriate messaging, audible indications, etc. In this case, the method 200 proceeds to 212 and the PCR system 38 continues storing the live conference call packets and selectively provides stored packets to the user as requested according to the subscriber PCR controls or commands. The method 200 again determines whether the conference call is over at 214, and if not (NO at 214), a determination is made at 216 as to whether the subscriber has chosen to rejoin the live conference call (e.g., by toggling the system mode using the soft key 54j in the example of FIG. 2B above). If so (YES at 216), the system 38 enters “live” mode at 217 and sets any optional mode indicators on the user display 54 and/or sends appropriate IP messaging or notices to other conference participants to indicate that the subscriber is again a live participant at 217, and the method returns again to 206 for live subscriber participation and continued PCR system recording of the conference call. Otherwise (NO at 216), the system 38 remains in the proxy mode and the method 200 returns to 212 as described supra. If the conference call is ended in the proxy mode (YES at 214), the method 200 proceeds to 220 in FIG. 4B, whereat the PCR continues selective provision of the stored packets to the subscriber according to the subscriber commands. A determination is then made at 222 as to whether the user has terminated the PCR session. If not (NO at 222), the PCR playback continues and the method returns to 220. Once the user ends the session (YES at 222), the PCR system 38 saves or stores the conference call IP packet stream for subsequent subscriber access.

Referring now to FIG. 5, the PCR system 38 can store multiple conference calls 301, 302 (in whole or in part) either until instructed to delete the calls or the system 38 may be configured to automatically delete the call data after a prescribed time period. In one possible implementation, the user can access the system 38 after the call is completed, and select from a listing of the stored conference calls, wherein the stored call data 301, 302 may include various information in addition to the actual call packets. In this example, the first stored call 301 includes a date indication 301a and a duration indicator 301b, as well as a listing of conference participants 301c. Furthermore, to assist the subscriber, the call 301 may provide indications 301d1, 301d2 showing one or more unheard portions of the stored call (e.g., portions where the subscriber was not a live participant). The exemplary second recorded or stored conference call 302 illustrates another possible situation in which the subscriber did not attend the conference at all, but instead used the system 38 to record the call for subsequent access. In this case, the stored call 302 indicates the call data and duration 302a, 302b, as well as the participant parties 302c, and indicates at 302d1 that the entire call is unheard. Once the user has reviewed all or portions of the stored calls 301, 302, moreover, the system 38 can update the indications 301d, 302d to indicate to the subscriber which portions (if any) remain unheard after such reviewing sessions.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention. Thus, while the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A telecommunications system, comprising:
a packet-switched telecommunications network;
a subscriber telecommunications device coupleable to the packet-switched telecommunications network to provide packet-based telephone service to a subscriber; and
a personal call recording system operatively coupled with the packet-switched telecommunications network to store a packet-based conference call involving the subscriber and at least two other parties, and to selectively playback at least a stored portion of the conference call to the subscriber during or after the conference call.

2. The system of claim 1, wherein the personal call recording system is implemented in a network server coupled with the packet-switched telecommunications network to provide personal call recording services for conference calls involving subscribers coupled with the packet-switched telecommunications network.

3. The system of claim 1, wherein the personal call recording system stores at least one of audio, video, and data for the conference calls involving the subscriber and at least two other parties.

4. The system of claim 1, wherein the personal call recording system is operable during the conference call according to a subscriber initiated mode change command to operate in either a first live mode or a second proxy mode, wherein the personal call recording system is operable in the proxy mode to store packets from the live conference call and to selectively playback stored packets to the subscriber device according to subscriber playback commands.

5. The system of claim 4, wherein the personal call recording system is operable after the conference call or during the conference call in the proxy mode to playback stored portions of the conference call to the subscriber at a subscriber-adjustable playback speed.

6. The system of claim 4, wherein the personal call recording system is operable during the conference call to indicate to the subscriber that the personal call recording system is in the proxy mode.

7. The system of claim 4, wherein the personal call recording system is operable during the conference call in the proxy mode to implement subscriber playback commands to change the current playback position.

8. The system of claim 4, wherein the personal call recording system is operable during the conference call in the proxy mode to indicate to other conference call parties that the subscriber has placed the personal call recording system into the proxy mode.

9. The system of claim 1, wherein the personal call recording system is operable during or after the conference call to playback stored portions of the conference call to the subscriber at a subscriber-adjustable playback speed.

10. The system of claim 1, wherein the personal call recording system is operable to attend the conference call in lieu of the subscriber and to store the conference call for subsequent access by the subscriber.

11. The system of claim 11, wherein the personal call recording system is operable during the conference call to indicate to other conference call parties that the personal call recording system is attending the conference call in lieu of the subscriber.

12. In a telecommunications system, a method for allowing selective participation by a subscriber in a conference call involving the subscriber and at least two other parties, the method comprising:
coupling a subscriber telecommunications device to a packet-switched telecommunications network;
storing packets from the network in a personal call recording system coupled with the network for a conference call involving the subscriber and two or more other parties; and
selectively playing back at least a stored portion of the conference call packets from the personal call recording system to the subscriber during or after the conference call.

13. The method of claim 12, further comprising joining the subscriber with the conference call via the packet-switched telecommunications network.

14. The method of claim 13, further comprising selectively operating the personal call recorder in either a first live mode in which the subscriber receives live packets for the conference call or in a second proxy mode in which the personal call recording system stores packets from the live conference call and selectively plays back stored packets to the subscriber device according to subscriber playback commands.

15. The method of claim 14, further comprising indicating to the subscriber whether the personal call recording system is in the proxy mode.

16. The method of claim 14, further comprising changing the current playback position according to subscriber playback commands.

17. The method of claim 14, further comprising indicating to other conference call parties whether the personal call recording system is in the proxy mode.

18. The method of claim 12, wherein selectively playing back at least a stored portion of the conference call packets comprises playing back stored portions of the conference call to the subscriber at a subscriber-adjustable playback speed.

19. The method of claim 12, comprising the personal call recording system attending the conference call in lieu of the subscriber and storing the conference call for subsequent access by the subscriber.

20. The method of claim 19, further comprising indicating to other conference call parties that the personal call recording system is attending the conference call in lieu of the subscriber.
